(19) United States
(12) Patent Application Publication
(10) Pub. No.: US 2016/0075108 A1
(43) Pub. Date: Mar. 17, 2016

(54) ACOUSTIC INSULATING PANEL

(71) Applicant: Hervey TREMBLAY, Thetford Mines (CA)

(72) Inventor: Hervey TEMBLAY, Thetford Mines (CA)

(21) Appl. No.: 14/889,451

(22) PCT Filed: May 8, 2014
(86) PCT No.: PCT/CA2014/000415

§ 371 Date: Nov. 6, 2015

Related U.S. Application Data
(60) Provisional application No. 61/821,055, filed on May 8, 2013.

(51) Int. Cl. B32B 7/12; G10K 11/168; B32B 3/12; B32B 15/08; B32B 7/08; B32B 9/04

(52) U.S. Cl. CPC B32B 7/12; B32B 7/08; B32B 9/04; B32B 3/12; B32B 15/08; G10K 11/168; B32B 2307/102; B32B 2419/00; B32B 2307/304

(57) ABSTRACT

An acoustic insulating panel includes at least one magnesium oxide board affixed to at least one low emissivity insulating sheet. The low emissivity insulating sheet is composed of two bubble-pack layers, each composed of two thermoplastic films forming there between a plurality of closed cavities, and a central film interposed between and bonded to the two bubble-pack layers. The central film is a thin foil of metal or a metallized thermoplastic film.

### CROSS REFERENCE TO RELATED APPLICATIONS

The present patent application claims benefit of prior U.S. Provisional Application for Patent Ser. No. 61/821,055 filed on May 8, 2013, which is incorporated herein by reference.

### TECHNICAL FIELD

The present disclosure relates to an acoustic insulating panel for main use in the building industry.

### BACKGROUND OF THE INVENTION

The present insulating panels used nowadays in the building industry to insulate floors, walls and the like, besides providing some load carrying capacity, only provide for heat conduction insulation, as well as sound (acoustic) insulation, in accordance with the different building codes. Also, such panels may provide a humidity barrier as well as being generally non-flammable (or at least retarding any fire propagation). However, these panels usually do not consider any insulation for heat radiation, which is not always negligible.

Accordingly, there is a need for an improved acoustic insulating panel.

### SUMMARY OF THE INVENTION

In order to overcome the limitations and problems discussed above, the main objective of the present invention is to provide for an improved acoustic insulating panel.

An advantage of the present invention is to provide an acoustic insulating panel having a good radiation heat insulation, due to at least a low emissivity sheet.

According to an aspect of the present invention, there is provided an acoustic insulating panel, comprising: a magnesium oxide board; and a low emissivity insulating sheet.

In one embodiment, the low emissivity insulating sheet is composed of: two bubble-pack layers, each composed of two thermoplastic films forming therebetween a plurality of closed cavities; and a central film interposed between and bonded to said two bubble-pack layers; wherein the central film is a thin foil of metal or a metallized thermoplastic film.

These and other advantages and objects will be apparent in view of the following detailed description in connection with the accompanying drawings.

### BRIEF DESCRIPTION OF THE DRAWINGS

Embodiments of the disclosure will be described by way of examples only with reference to the accompanying drawings, in which:

FIG. 1 is a perspective view of an acoustic insulating panel in accordance with a first illustrative embodiment of the present disclosure;

FIG. 1a is a perspective magnified view of a part of a low emissivity insulating sheet of the acoustic insulating panel of FIG. 1;

FIG. 2 is a perspective view of an acoustic insulating panel in accordance with a second illustrative embodiment of the present disclosure; and

FIG. 3 is a perspective view of an acoustic insulating panel in accordance with a third illustrative embodiment of the present disclosure.

Similar references used in different Figures denote similar components.

### DETAILED DESCRIPTION OF THE INVENTION

Generally stated, the non-limitative illustrative embodiments of the present disclosure provide an acoustic insulating panel composed of a magnesium oxide board combined with a low emissivity insulating sheet. A low emissivity generally refers to an effective optical emissivity of a surface in the infrared (IR) electromagnetic spectrum (since the surfaces with temperatures within the normal environmental temperature range from about −100° C. to about +100° C. emit radiations in the infrared electromagnetic spectrum). That effective optical emissivity, generally equal to the IR absorptance of such a surface, should be of about less than 0.75, preferably less than 0.55, and most preferably less than 0.45 (such that the reflectance is at least 0.25, preferably at least 0.45, and most preferably at least 0.55).

In order to get such an effective low emissivity, a low emissivity surface (highly reflective surface), typically found on metallic or metallized (with a thin layer of about half to few thousands of an inch of a metal deposition) surfaces (emissivity less than 0.2, preferably less than 0.05, and most preferably less than 0.03), is positioned behind a partially transparent material, in the IR spectrum. Typically, a metallic of metallized surface is positioned behind a transparent thermoplastic film, as detailed hereinafter. A low emissivity insulating panel significantly reduces the heat transfer by radiation there through, in addition to also reduce the heat transfer by conduction.

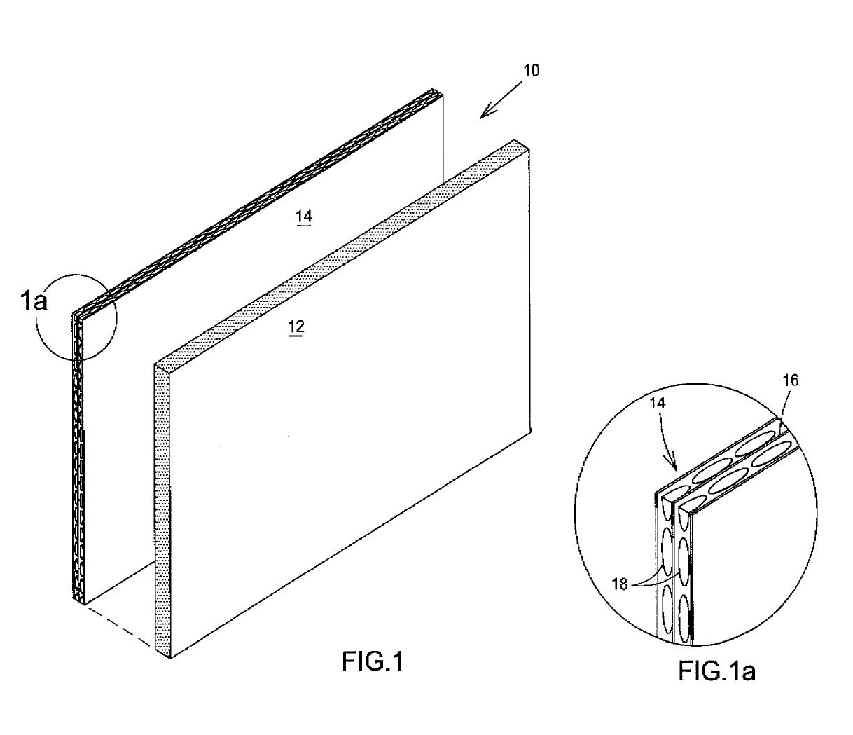

Referring to FIG. 1, the acoustic insulating panel 10, in accordance with a first illustrative embodiment of the present disclosure, generally comprises a magnesium oxide board 12 to which is affixed a low emissivity insulating sheet 14 using, for example, staples or an adhesive.

The magnesium oxide board 12 is a ¾ of an inch magnesium oxide, magnesium chloride, perlite, sawdust and fiber glass laminate panel, for example a MgO panel distributed by Magnum BP™ (British Petroleum).

With further reference to FIG. 1a, the low emissivity insulating sheet 14 is composed of a central film 16, in the form of a thin foil of metal or a metallized thermoplastic film, interposed between and bonded to two bubble-pack layers 18, each formed of two thermoplastic films forming therebetween a plurality of closed cavities (of entrapped air or the like gas), for example an INSUL-R™ sheet or an r-Foil™ insulating sheet as disclosed in U.S. Pat. Nos. 6,562,439 or 6,514,596, the contents of which are hereby incorporated by reference.

The acoustic insulating panel 10 may be used as a subfloor, ceiling and/or walls.

The combination of the magnesium oxide board 12 and the low emissivity insulating sheet 14 provides for increased strength, when used for flooring, to receive a floor finishing such as wood, ceramic, carpet etc., resists moisture, mildew and insects while possessing superior qualities. It also helps eliminate impact noise and those caused by sound transmission. For example, on a concrete floor of a standard thickness, the acoustic insulating panel 10 provides a field impact insulation class (FIIC) of about 65 dB, high above common Building Code minimum requirements.

Furthermore, the acoustic insulating panel 10 provides for a combination that is fire resistant, has excellent thermal and reflective properties, provides pneumatic absorption and can withstand a compression of about 140 psi.

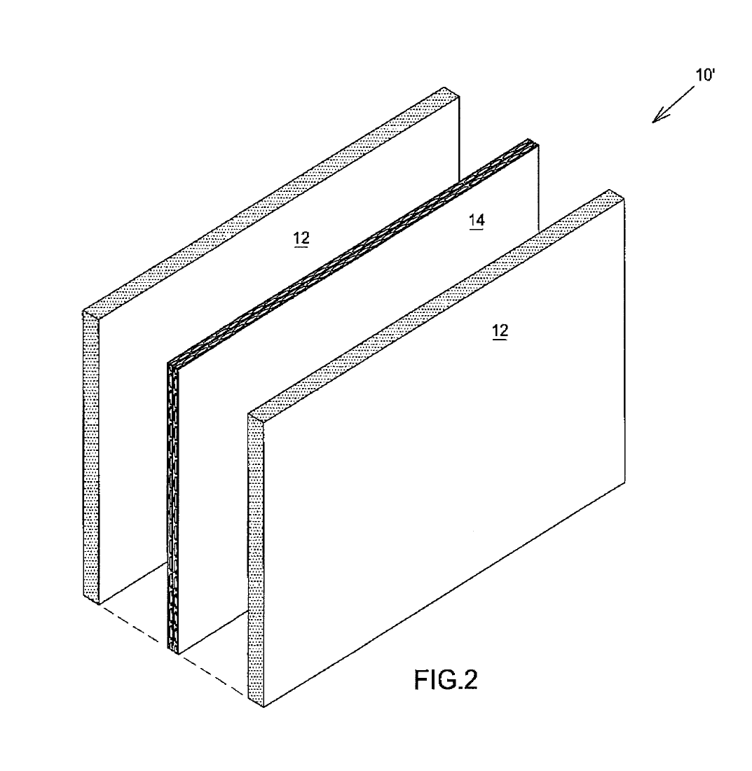

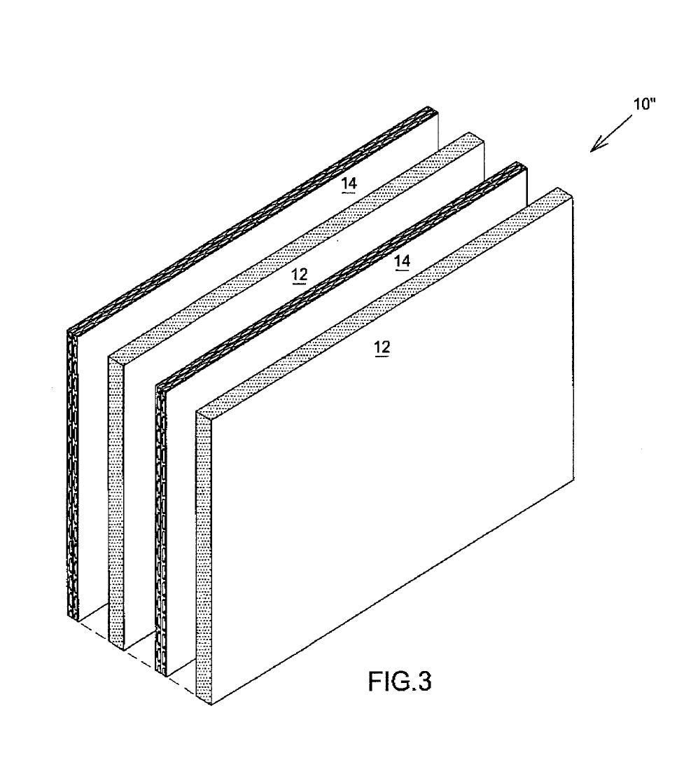

It is to be understood that the insulation strength and/or emissivity properties of the acoustic insulating panel 10 may be improved by providing it with multiple magnesium oxide boards 12 and/or low emissivity insulating sheets 14. For example, FIG. 2 shows an acoustic insulating panel 10′ in accordance with a second illustrative embodiment which generally comprises two magnesium oxide boards 12 between which is affixed a low emissivity insulating sheet 14, while FIG. 3 shows an acoustic insulating panel 10″ in accordance with a third illustrative embodiment which generally comprises two magnesium oxide boards 12 interspaced with two low emissivity insulating sheets 14.

It is to be understood that the acoustic insulating panels 10, 10′, 10″ may be produced in various sizes and shapes, and may also be provided with flanges and corresponding grooves in order to facilitate their installation by fitting one into another. It is also to be Understood that in another alternative embodiment the thickness of the magnesium oxide boards 12 may vary and that in a further alternative embodiment the composition of the magnesium oxide board 12 and the low emissivity insulating sheet 14 may slightly vary.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope of the present disclosure and as hereinafter claimed.

What is claimed is:

1. An acoustic insulating panel, comprising:
a magnesium oxide board; and
a low emissivity insulating sheet.

2. The acoustic insulating panel of claim 1, wherein the low emissivity insulating sheet is composed of:
two bubble-pack layers, each composed of two thermoplastic films forming therebetween a plurality of closed cavities; and
a central film interposed between and bonded to said two bubble-pack layers;
wherein the central film is a thin foil of metal or a metallized thermoplastic film.

3. The acoustic insulating panel of claim 2, further comprising a second magnesium oxide board, the low emissivity insulating sheet being positioned between the two magnesium oxide boards.

4. The acoustic insulating panel of claim 2, further comprising a second magnesium oxide board and a second low emissivity insulating sheet, the two magnesium oxide boards being interspaced with the two low emissivity insulating sheets.

5. The acoustic insulating panel of claim 1, wherein the magnesium oxide board is affixed to the low emissivity insulating sheet using an adhesive.

6. The acoustic insulating panel of claim 1, wherein the magnesium oxide board is affixed to the low emissivity insulating sheet using staples.

7. The acoustic insulating panel of claim 1, wherein the magnesium oxide board is a magnesium oxide, magnesium chloride, perlite, sawdust and fiber glass laminate panel.
